(19) United States
(12) Patent Application Publication
(10) Pub. No.: US 2023/0289164 A1
(43) Pub. Date: Sep. 14, 2023

(54) USER INTERFACE FOR APPLYING AN EXISTING SERVER IMAGE TO A CLUSTER

(71) Applicant: VMware, Inc., Palo Alto, CA (US)

(72) Inventors: Branislav Abadzhimarinov, Sofia (BG); Ledda Grigorova-Borisova, Sofia (BG)

(21) Appl. No.: 17/689,141

(22) Filed: Mar. 8, 2022

(51) Int. Cl. G06F 8/61; G06F 9/451; G06F 9/455

(52) U.S. Cl. CPC G06F 8/63; G06F 9/451; G06F 9/45558; G06F 2009/45595

(57) ABSTRACT

Systems and methods are described for providing a Graphical User Interface (“GUI”) for applying an existing image to a server cluster. The existing image can come from a host known or unknown to a system. For a known host, using the GUI a user can select a host from a list of known hosts. A server can import an image file for the selected host and create a server cluster with the image file. For an unknown host, using the GUI the user can input an address and access credentials for the unknown host. The server can use the address and access credentials to import an image file and create a server cluster. Using the GUI, the user can also apply an existing image to hosts in an existing server cluster or use an existing image to add new hosts to a cluster.

### BACKGROUND

Server clustering is a common method used to expand availability of applications and services to clients. Servers in a cluster function together and can work simultaneously under a single IP address. An organization can add or remove servers from a cluster based on consumer demand. Creating and modifying server clusters has become dynamic with the use of virtual machines (“VMs”). VMs can be installed, uninstalled, and migrated across physical servers in a network.

Server clustering can require that the VMs in the cluster be running the same operating system (“OS”) or image. Current methods for creating and managing server clusters require that the image used in the management interface be selected from a set of preselected image files. For example, when assigning a single image to a cluster in VMWARE's VSPHERE LIFE CYCLE MANAGER (“VLCM”), the only available option to pick an image during cluster creation is to select the image from a depot. The depot must be prepopulated with images prior to creating the cluster. VMWARE and other organizations publish official depots with host images that are available online. However, this option is not available for images in air-gapped environments because the host is isolated or otherwise not accessible to other server clusters. To be able to use the image of an air-gapped host, an administrator (“admin”) must manually find and download the desired image file. Only then can the image file be used for single use or uploaded into a depot like the VLCM depot.

As a result, a need exists for extracting image files from hosts and applying the image to new or existing server clusters.

### SUMMARY

Examples described herein include systems and methods for providing a Graphical User Interface (“GUI”) for applying an existing server image to a server cluster. The GUI can be part of an application for managing server clusters that is hosted by an application server. Actions described herein as being performed by the GUI can be performed by the corresponding application or application backend on the application server rather than the GUI itself.

The GUI can provide options for creating a server cluster based on a single image. As used herein, the term “image” can refer to an OS, any executables in the OS, and any data files related to programs installed on the OS. Two such options for creating the server cluster can allow the user to select an image already running on a host. A first option can allow the user to pick an image from a host that is part of an inventory of known hosts in a system. As used herein, these known hosts are referred to as “existing hosts.” If the user selects this option, the GUI can present a list of hosts that the user can choose from. When the user selects a host, the application server can extract or import the host's image and create a new server cluster in which all the hosts run the imported image.

A second option can allow a user to extract an image from a host not in the inventory of known hosts. As used herein, these unknown hosts are referred to as “new hosts.” If the user selects this option, the GUI can prompt the user to provide an address for the new host, such as an Internet Protocol (“IP”) address or fully qualified domain name (“FQDN”). The GUI can also prompt for access credentials, such as a username and password. The application server can use the new host's address and access credentials to retrieve an image file from the new host. The application server can then create a server cluster with all the hosts running the new host's image. The GUI can include an option that allows the user to make the new host available as an existing host. In other words, when creating a new cluster in the future, the new host can appear in the list of existing hosts for image extraction.

The GUI can allow the user to modify an image before applying the image to the new server cluster. For example, the GUI can include a feature that allows the user to add or remove components of the image. As an example, the user can add, remove, or change drivers, executables, or applications. After the user confirms the changes, the application server can create the server cluster with the modified image. The GUI can also include a feature that allows the user to add the selected host to the server cluster.

In addition to creating a new cluster based on an existing image, the GUI can allow a user to add new hosts to an existing cluster with an existing image and apply an existing image to an existing cluster. For example, the user can select an option for adding hosts to a cluster, and the GUI can allow the user to choose to use a new image, an image from an existing host, or an image from a new host for the new hosts. If the user chooses one of the options for using an existing image, the user can either select an existing host or provide information for a new host, similar to the process for creating a new server cluster described previously. The application server can then create new hosts for the server cluster using the extracted image. The GUI can also allow the user to apply the extracted image to the hosts already in the cluster. The user can also add the selected host to the cluster, if desired.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for creating a server cluster based on an image from an existing host.

FIG. 2 is a sequence diagram of an example method for creating a server cluster based on an image from an existing host.

FIG. 3 is a flowchart of an example method for creating a server cluster based on an image from a new host.

FIG. 4 is a sequence diagram of an example method for creating a server cluster based on an image from a new host.

FIG. 5 is a flowchart of an example method for adding hosts to a server cluster managed with a single image.

FIG. 6 is a sequence diagram of an example method for adding hosts to a server cluster managed with a single image.

FIGS. 7A, 7B, 7C, 7D, 7E, 7F are illustrations of an example GUI for creating a server cluster using an existing image.

FIGS. 8A and 8B are illustrations of an example GUI for applying an image from an existing host to a server cluster.

FIG. 9 is an illustration of an example system for applying an existing server image to a cluster.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for providing a GUI for applying an existing image to a server cluster. The existing image can come from an existing host or new host to a system. For an existing host, using the GUI a user can select a host from a list of existing hosts. A server can import an image file for the selected host and create a server cluster with the image file. For a new host, using the GUI the user can input an address and access credentials for the new host. The server can use the address and access credentials to import an image file and create a server cluster. The GUI can also allow the user to view and modify components of the imported file before creating the server cluster. Using the GUI, the user can also apply an existing image to hosts in an existing server cluster or use an existing image to add new hosts to a cluster

References are made throughout to a GUI for applying server images to new and existing server clusters. The GUI can be a front-end interface of an application that a user can interact with for managing server clusters. The application can be hosted by one or more servers or a group of servers (referred to throughout as the “application server”), including multiple servers implemented virtually across multiple computing platforms. For example, the application can be hosted by a web server, and a user can access the application through a web browser. Alternatively, the application as a whole, the GUI, or other components of the application may be installed directly on a user's device. Actions described herein as being performed by the GUI can be performed by the corresponding application or service rather than the GUI itself.

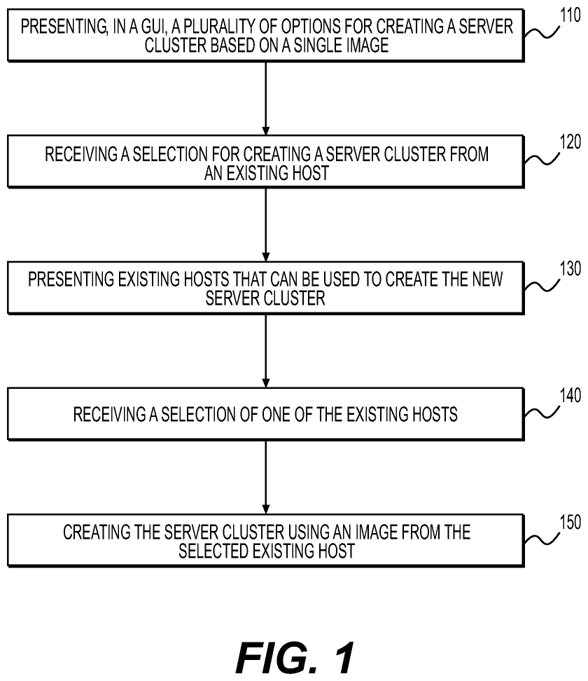

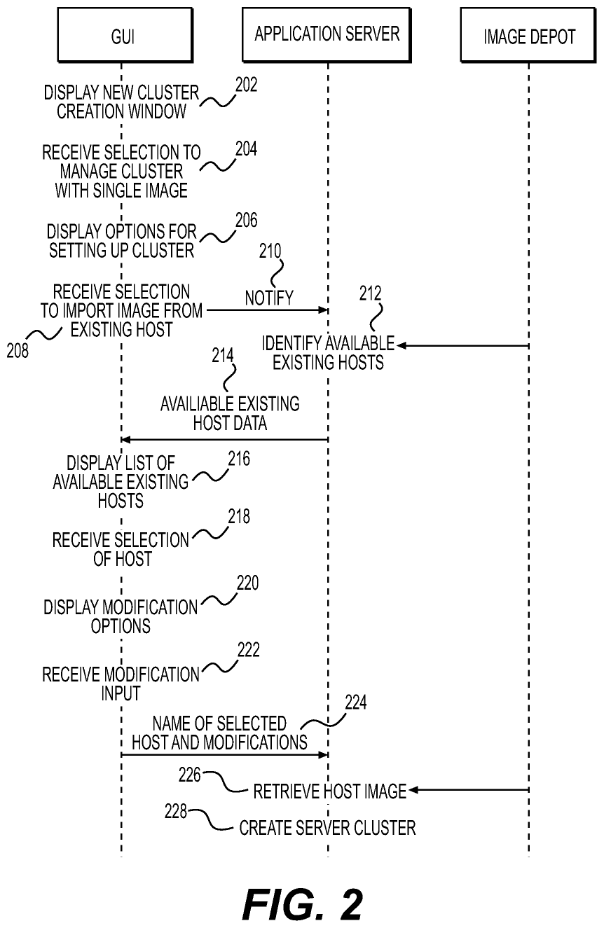

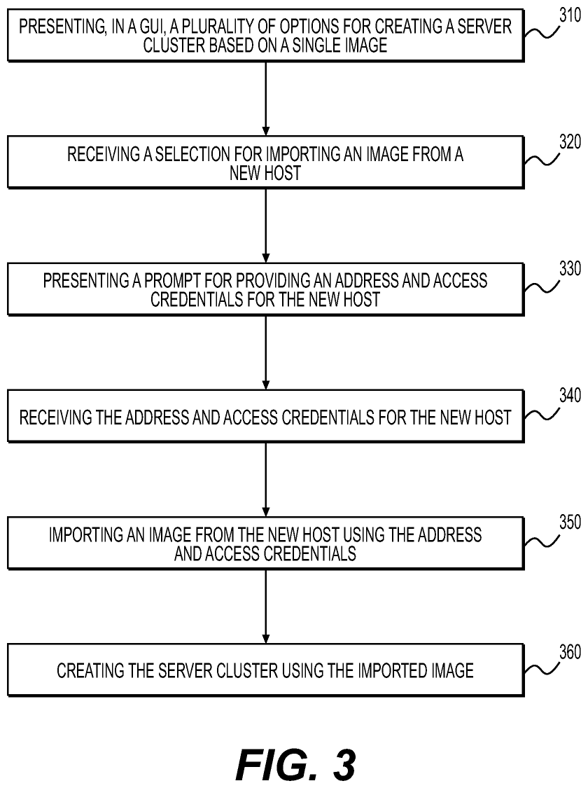

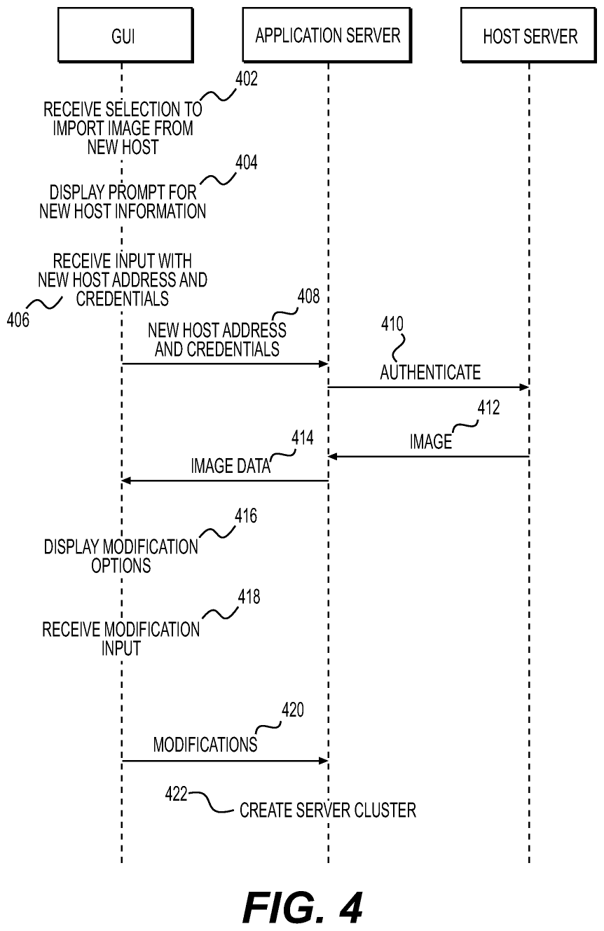

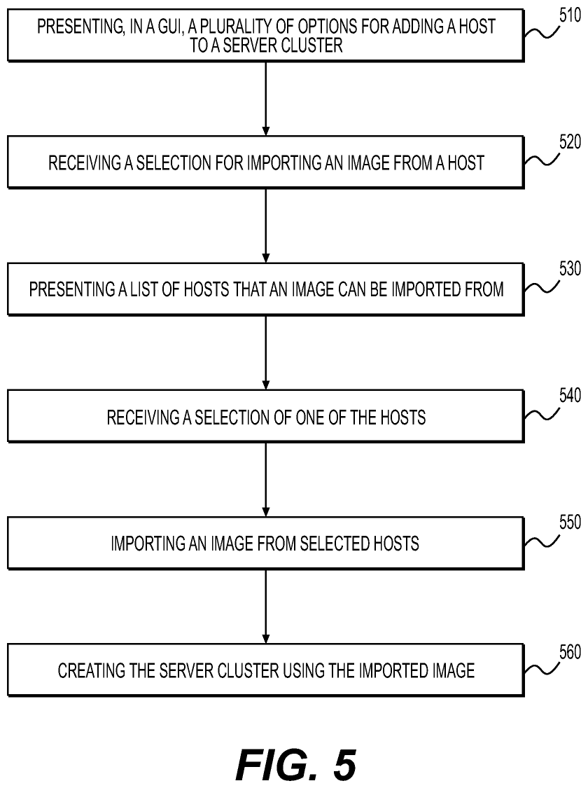

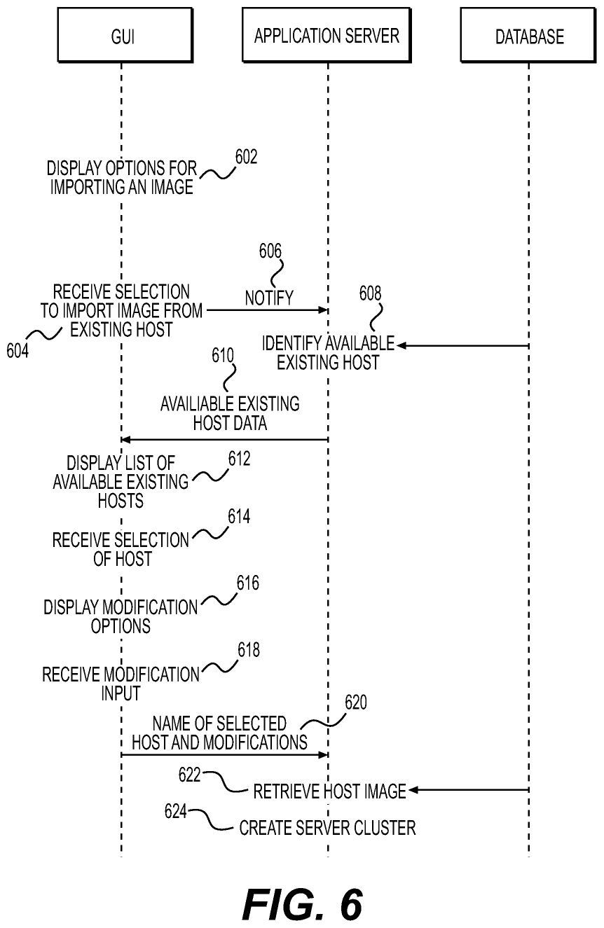

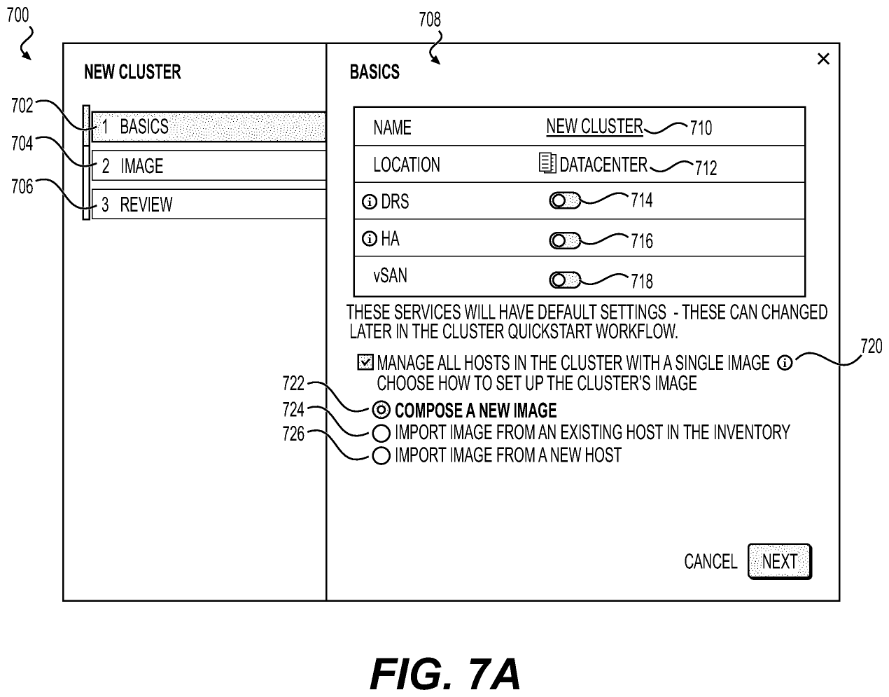

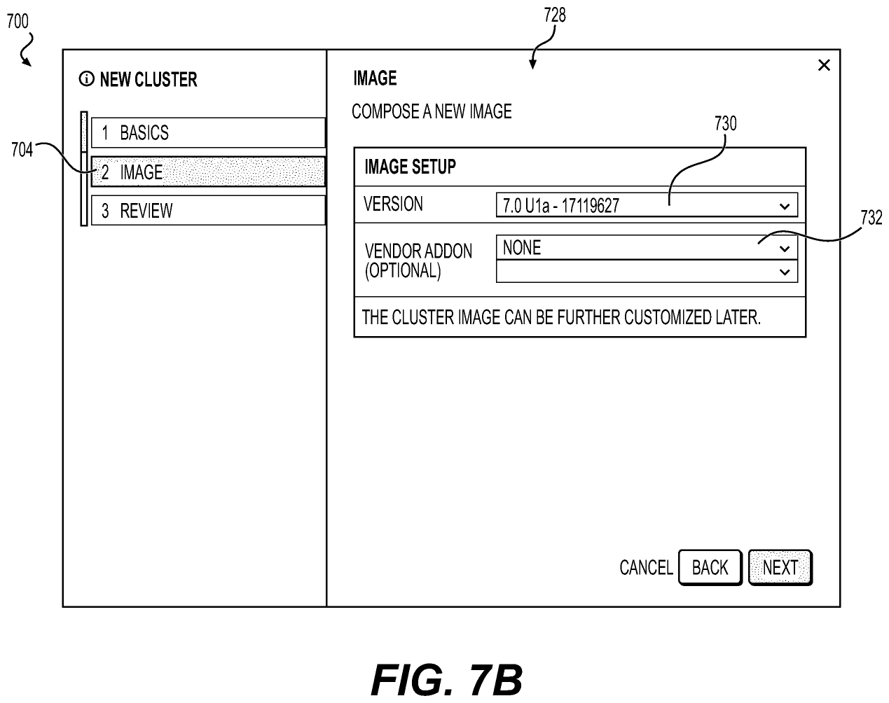

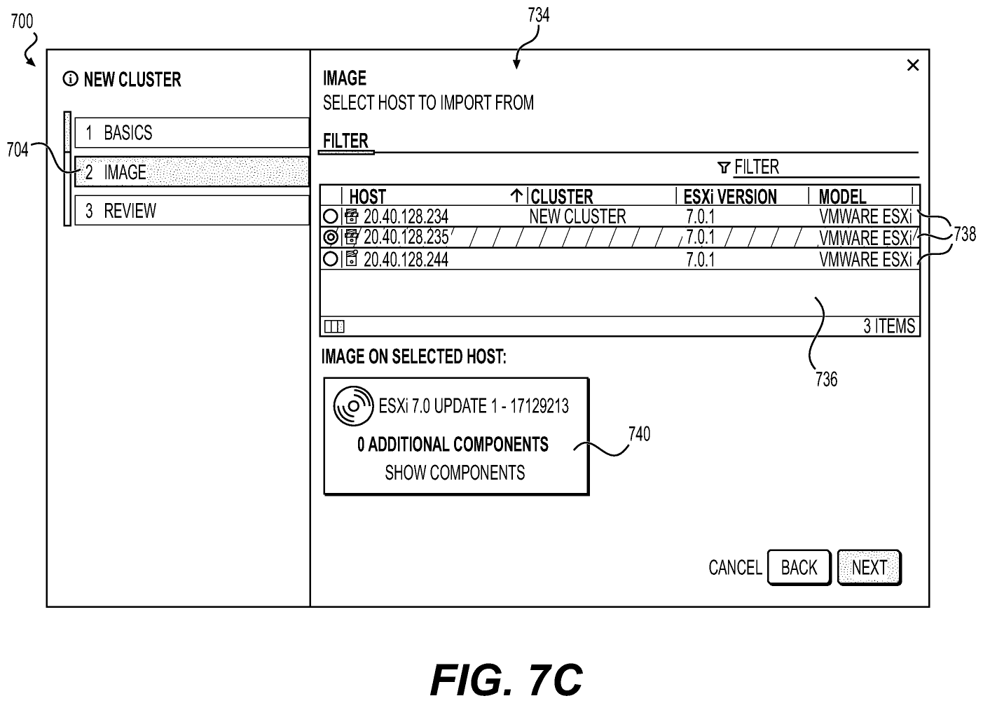

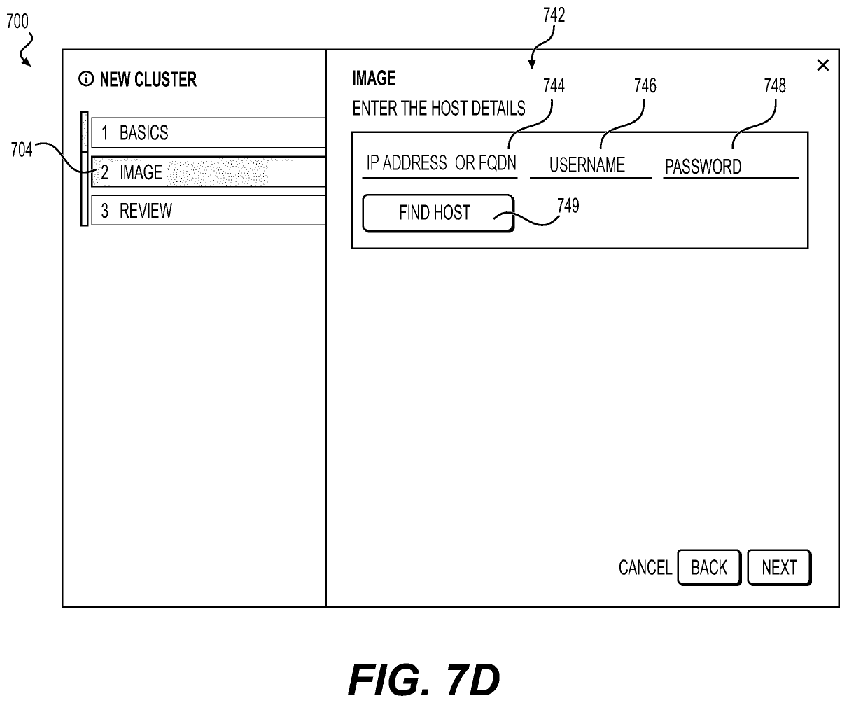

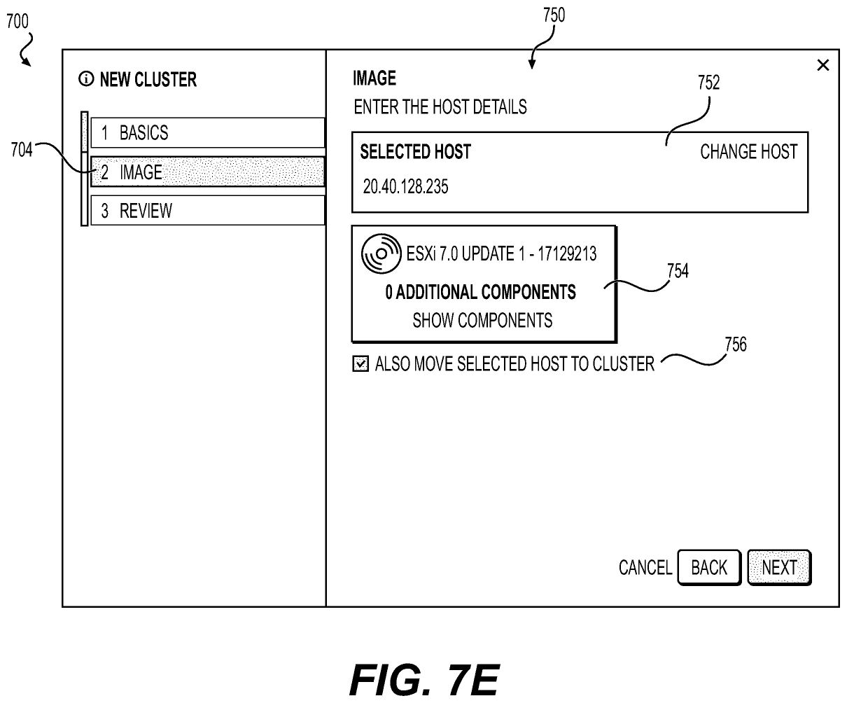

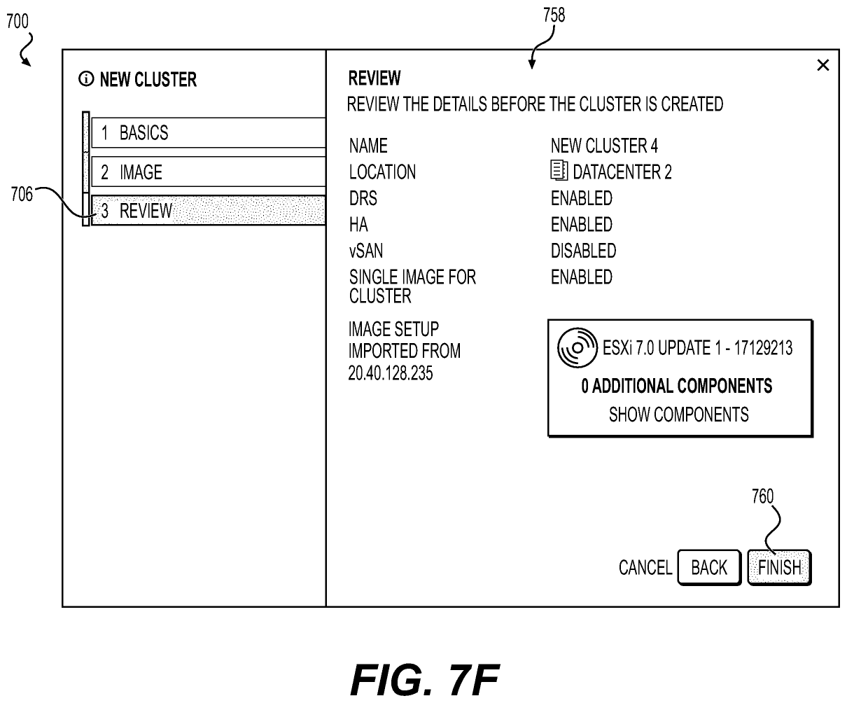

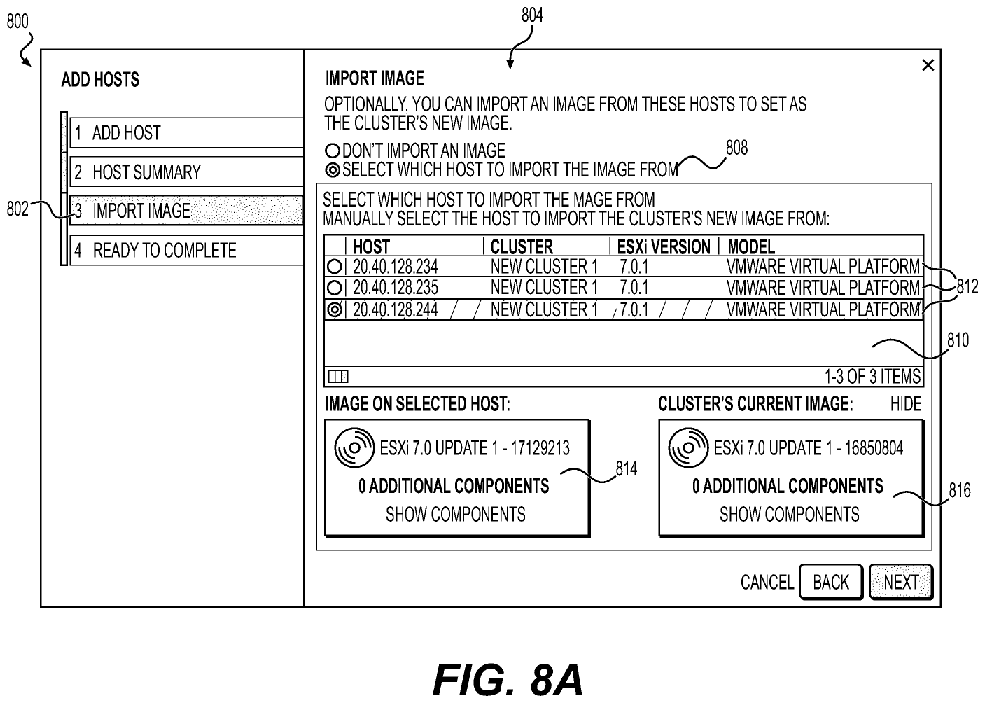

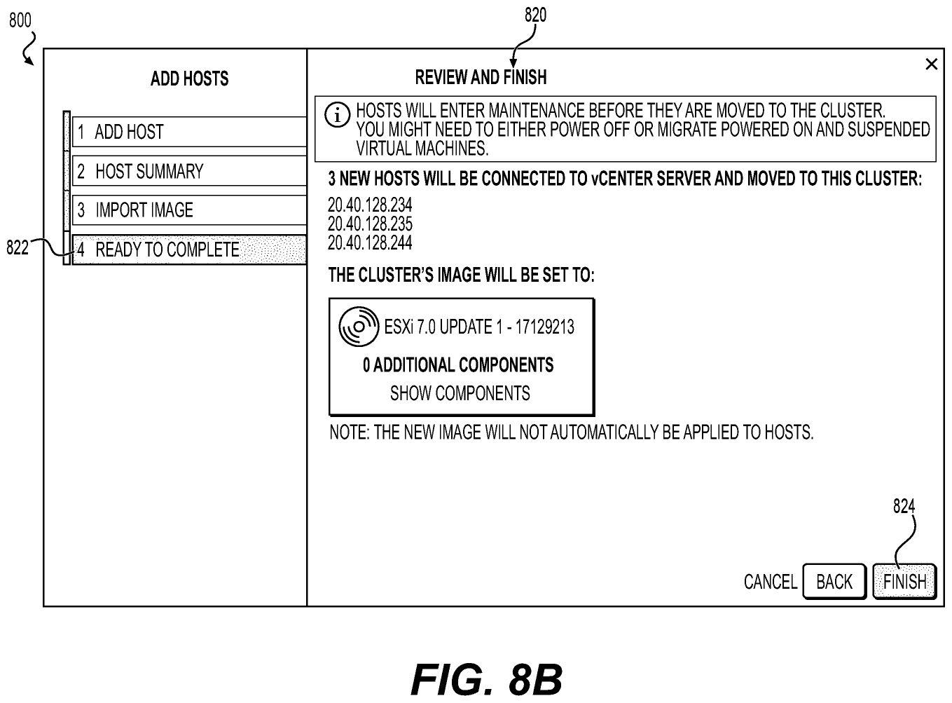

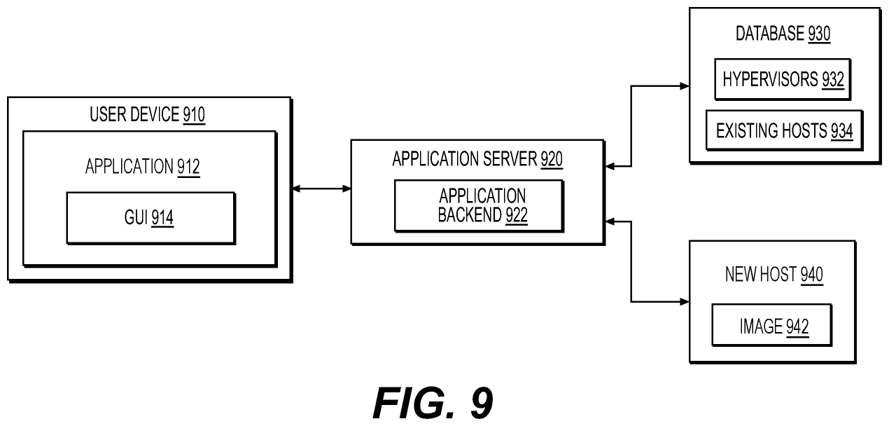

FIG. 1 is a flowchart of an example method for using the GUI to create a server cluster based on an existing image from an existing host. FIG. 2 is a sequence diagram of the example method described in FIG. 1. FIG. 3 is a flowchart of an example method for using the GUI to create a server cluster based on an existing image from a new host. FIG. 4 is a sequence diagram of the example method described in FIG. 3. FIG. 5 is a flowchart of an example method for using the GUI to add hosts to a server cluster using an existing image from a new or existing host. FIG. 4 is a sequence diagram of the example method described in FIG. 3. FIGS. 7A, 7B, 7C, 7D, 7E, 7F are illustrations of an example GUI that can be used to perform the example methods described in FIGS. 1, 2, 3, and 4. FIGS. 8A and 8B are illustrations of an example GUI that can be used to perform the example methods described in FIGS. 5 and 6. FIG. 9 is an illustration of an example system for performing the methods described herein.

FIG. 1 is a flowchart of an example method for creating a server cluster based on an image from an existing host. At stage 110, a GUI can present options for creating a new server cluster (referred to interchangeably throughout as “new server cluster,” “server cluster,” or simply “cluster”). As used herein, the term “server cluster” can refer to a group of VMs that work together so that they are viewed as a single system from an endpoint perspective. The VMs in a cluster can be hosted on one or more physical computing devices, such as servers, with a hypervisor that runs VMs.

To access the GUI, a user can launch an application for managing servers, and the application can cause the GUI to be displayed on the user's device. The GUI can include various options for managing servers, including, for example, creating a server cluster. If the user selects an option for creating a server cluster, then the GUI can present a new cluster window that includes configuration options for the new server cluster. The new cluster window can allow the user to assign a name to the new cluster and designate where the cluster will be hosted. For example, if an organization has multiple data centers, then the user can choose which data center will host the server cluster.

The GUI can include an option for managing all hosts in the cluster with a single image. As used herein, the term “image” can refer to a copy of a server, or more specifically its operating system. Selecting this option can cause the GUI can present options for setting up the cluster's image. For example, the GUI can display options for composing a new image, importing an image from an existing host, and importing an image from a new host.

At stage 120, the GUI can receive a selection for creating a server cluster from an existing host. The GUI can receive the selection and inform the application server. In response, the application server can retrieve a list of existing hosts in the system that are available for host seeding. As used herein, the term “existing host” refers to a known host in a system that is available for host seeding. The term “host seeding” refers to providing an image for use by other hosts. For example, information about existing hosts (i.e. hosts that the system knows are available for host seeding) can be stored in a database that the application server can access. Host seeding availability can depend on a variety of factors. For example, users can be assigned policies that determine which hosts they can import an image from. Also, admins can designate whether a host's image can be used for host seeding. Authentication information for existing hosts can be accessible by the application server, and authenticating with the GUI can allow a user to use an image of an existing host without any further authentication.

The term “new host” is used later herein to refer to hosts that can be used for host seeding that are not yet known to the system. For example, a user can provide information about a new host that the application server can use to retrieve an image file. An example method for creating a server cluster is described in detail later herein regarding FIGS. 3 and 4. While a new host is also “existing,” the terms “existing host” and “new host” are used herein to differentiate between hosts that a system knows and does not know are available for host seeding. For example, an existing host can be a host that the system knows exists and knows is available for host seeding. A new host, on the other hand, can be a host that the system does not know exists or a host that the system knows exists but is not available for host seeding. As an example, a new host can be a host that is intentionally isolated from other networks or server clusters. A new host can also be a host that the system cannot communicate with because the system does not have the required access credentials.

At stage 130, the GUI can present existing hosts that can be used for host seeding. For example, the GUI can display a list of the existing hosts and information about the host's image. The image information can include the host's name, IP address, hypervisor version, and model, as some examples. Added components that were installed at the host, such as additional drivers or applications, can also be presented as added to the image. The image information can also indicate a cluster that the host belongs to. The GUI can include a filtering tool that allows the user to locate the desired existing host more quickly. For example, the filtering tool can include a text field that actively filters the results based on user input. As an example, the user can input the IP address of the desired existing host. As the user inputs the IP address, the GUI can filter out hosts whose IP address does not match.

At stage 140, the GUI can receive a selection of one of the existing hosts. For example, the user can select a host from the list of existing hosts described above. Before creating a server cluster based on the selected host's image, the GUI can allow the user to customize the image. For example, when the user selects a host, the GUI can make an Application Programming Interface (“API”) call to a retrieve the image information for the selected host. The image information can include information like the image's identifier (“ID”), OS version, executables, application data files, installed drivers, and so on. The GUI can then allow the user to customize certain aspects of the image, such as by adding or removing drivers or other components. Components that were added to the selected host, such as applications and drivers, can be separately displayed for selection or deselection by the user for inclusion as part of the image.

At stage 150, the server cluster can be created using the image from the selected existing host. For example, the application server can create a cluster of VMs based on the selected host's image. The VMs can be installed on host devices in a location designated by the user, such as a specified data center. The application server can add and remove components from the selected image according to the modifications made by the user. The GUI can allow the user to add the selected existing host to the server cluster in certain circumstances. For example, if the existing host is a standalone host (i.e., not part of a server cluster), then the GUI can present an option, such as a toggle button, that the user can select to add the existing host to the new server cluster.

FIG. 2 is a sequence diagram of an example method for creating a server cluster based on an image from an existing host. At stage 202, the GUI can display a new cluster creation window. For example, a user can launch an application for managing servers, and the application can cause the GUI to be displayed on the user's device. The GUI can include various options for managing servers, including an option for creating a server cluster. The user can select this option, which can cause the GUI can present a new cluster window that includes configuration options for the new server cluster.

At stage 204, the GUI can receive a selection to manage the new server cluster with a single image. This stage can be optional, however, and the GUI can proceed to stage 206 without requiring any such selection from the user. At stage 206, the GUI can present options for setting up the cluster's image. For example, the GUI can display options for composing a new image, importing an image from an existing host, and importing an image from a new host.

At stage 208, the GUI can receive a selection to create the cluster using an image from an existing host. For example, the GUI options can be selection mechanisms that the user can select. Upon making the selection, at stage 210, the GUI can notify the application server.

At stage 212, the application server can identify existing hosts that are available for host seeding. This can allow the user to bootstrap a cluster of hosts with a desired image. For example, the application server can have access to data relating to existing hosts in a system that are available for host seeding. Such data can be stored in a database, for example. The application server can retrieve data about the existing hosts and cause the data to be displayed in the GUI. For example, the application server can make an API call or database query to retrieve the host data.

At stage 214, the application server can send the host data to the GUI with instructions for presenting the hosts and their corresponding data as an ordered list. The GUI can then display the list of existing hosts at stage 216. The GUI can include an active filter that allows the user to filter out existing hosts by any categories of the host data, such as the host's IP address, ID, OS version, model, and so on.

At stage 218, the user can select a host displayed in the GUI. In response, the application server can make an API call to the corresponding host to retrieve information about the host's image. Such image information can include information like the image's OS version, executables, application data files, installed drivers, and so on. The application server can then cause the image information to be displayed for the user.

At stage 220, the GUI can display modification options for the image. For example, the GUI can allow the user to modify the image before the server cluster is created. As some examples, the user can add or remove drivers, executables, and so on. The modification options can be displayed in response to the user selecting a selection mechanism in the GUI. When the user selects to modify the image, the GUI can display a window with a list of modifications that can be made. For example, the GUI can display a list of components of the image that can be added, removed, or modified. The GUI can also include a feature that allows the user to add new components to the image, such as new drivers, executables, and applications. For example, the application server can have a library of applications that can be added to an image. These applications, and any other components that can be readily added, can be displayed in the GUI for the user choose. The GUI can also allow a user to upload drivers to be used in addition to, or in lieu of, the drivers in the current image.

At stage 222, the GUI can receive modification input from the user. For example, the user can select components to add or remove, upload any data files, and select any applications or other options to add or remove. At stage 224, the GUI can send the ID of the selected host and any modifications to the application server. For example, the GUI can create a data file, such as a Hypertext Markup Language (“HTML”) file or a JavaScript Object Notation (“JSON”) file, that includes the image ID and modifications. The GUI can send the file to the application server, such as with an HTTP or API call.

At stage 226, the application server can retrieve the image corresponding to the selected existing host from the image depot. For example, the application server can send instructions to the existing host to create an image file and send it to the application server. Upon receiving the image file, at stage 228, the application server can create the server cluster using the existing host's image. In an example where the user opts to add the existing host to the cluster, the application server can reconfigure the existing host accordingly.

FIG. 3 is a flowchart of an example method for creating a server cluster based on an image from a new host. As described previously, a new host already exists, but is unknown to the system regarding host seeding availability. For example, a host may be part of a cluster that is isolated from the system, and the host may therefore be unknown to the system. At stage 310, a GUI can present options for creating a server cluster. For example, the GUI can be the same, or similar to, the GUI described at stage 110 of FIG. 1 above. For example, the GUI can include various options for managing servers, including, for example, creating a server cluster. If the user selects an option for creating a server cluster, then the GUI can present a new cluster window that includes configuration options for the new server cluster. The new cluster window can allow the user to assign a name to the new cluster and designate where the cluster will be hosted. For example, if an organization has multiple data centers, then the user can choose which data center will host the server cluster.

The GUI can include an option for managing all hosts in the cluster with a single image. Selecting this option can cause the GUI can present options for setting up the cluster's image. For example, the GUI can display options for composing a new image, importing an image from an existing host, and importing an image from a new host. At stage 320, the GUI can receive a selection for importing an image from a new host.

In response to the selection, at stage 330, the GUI can present a window for providing an address of a new host and access credentials. The GUI can accept various formats for the new host's address, such as an IP address or a fully qualified domain name (“FQDN”). An FQDN can be a complete domain name for a specific host. The access credentials can be required to access the new host. For example, the new host can require that the proper access credentials be provided before allowing communications with any unknown device. The access credentials may therefore be required for retrieving the new host's image file. The GUI can receive the access credentials in any designated format, such as a username and password.

At stage 340, the GUI can receive the address of the new host and access credentials. For example, the user can input the IP address or FQDN of the new host and access credentials for authenticating with the new host. The GUI can send the address and access credentials to the application server, which the application server can use to authenticate the user and retrieve the host's image. For example, if the user enters an IP address for the new host, then the application server can make a Hypertext Transfer Protocol (“HTTP”) call with the IP address to contact the new host. If the user provides an FQDN, then the application server can first contact a Domain Name System (“DNS”) server with the FQDN to retrieve its corresponding IP address. The application server can present the access credentials to authenticate the user. If authentication fails, then the GUI can prompt the user accordingly.

At stage 350, the application server can import an image from the new host. For example, after successfully authenticating with the access credentials, the application server can request an image of the new host. If the new host has such capability, then the new host can prepare an image file and send the image file to the application server. Before retrieving the image file, which can be large and require significant bandwidth to retrieve, the application server can first request information about the new host's image, such as the OS version, executables, application data files, installed drivers, and so on. The GUI can also allow the user to customize certain aspects of the image, such as by adding or removing drivers or other components. Then user can then select a button or other mechanism in the GUI indicating that the user has finished reviewing and customizing the image, and the application server can then import the image file from the new host and add the corresponding customizations.

In an example, before importing the image, the application server can verify the new host's certificate. For example, if the new host is not known to the application server, the application server can request the new host's Secure Sockets Layer (“SSL”), Transport Layer Security (“TLS”), or other certificate. If the application server is unable to verify the certificate, then the GUI can notify the user and prompt the user to proceed if the user trust's the certificate or to cancel the process.

The GUI can have an option to make the new host available for future host seeding. For example, the user can select an option that causes the application server to add the new host as an existing host described in FIG. 1 above. When another user, using the GUI, selects to bootstrap a cluster of hosts using an existing image, the new host can then appear in the list of available hosts to choose from. The application server can use the retrieved image file or retrieve a new image file when the new host is later selected for host seeding. For example, the application server can retain the retrieved image file in a database so that it can be available for future seeding. Retaining the image file can be particularly useful in situations where, as an example, the new host may not be available later to retrieve a new image file. For example, an admin can configure the new host to be available to provide an image file as a one-time occurrence, and after providing the image file, the new host can become unreachable. As an example, if the new host is typically air-gapped, an admin can connect the new host to a network temporarily so that the image file can be retrieved. Even if the host is not available later on, the retrieved image file can still be made available for creating future server clusters.

Alternatively, after first accessing the new host with the access credentials, the new host can provide a security certificate that the application server can use to retrieve a new image file. Although this method requires additional time and bandwidth usage, retrieving a new image file can be beneficial when updates or other changes have been applied to the new host since the last image retrieval. The GUI can allow a user to choose between versions when the new host is still available. For example, if the user selects the new host, the GUI can prompt the user to choose between using the older version of the image or retrieving a new version.

At stage 360, the server cluster can be created using an image from the selected existing host. For example, the application server can create a cluster of VMs based on the imported image. The VMs can be installed on host devices in a location designated by the user, such as a specified data center. The application server can add and remove components from the selected image according to the modifications made by the user.

FIG. 4 is a sequence diagram of an example method for creating a server cluster based on an image from a new host. The example method described below can begin after stage 206 of FIG. 2. For example, prior to stage 402, the GUI can display a new cluster creation window, the user can select to manage the cluster with a single image, and then the GUI can display options for setting up the cluster. The options can include using an image from an existing host and importing an image from a new host.

At stage 402, the GUI can receive a selection to import an image from a new host. In response, at stage 404, the GUI can display a prompt for new host information, including an address of the new host and access credentials. The GUI can accept various formats for the new host's address, such as an IP address or an FQDN. The GUI can receive the access credentials in any designated format, such as a username and password.

At stage 406, the user can input the new host information. For example, the user can input the IP address or FQDN and the access credentials. At stage 408, the GUI can send the new host information to the application server. At stage 410, the application server can contact the new host and authenticate using the access credentials. For example, if the user enters an IP address for the new host, then the application server can make an HTTP call with the IP address to contact the new host. If the user provides an FQDN, then the application server can first contact a DNS server with the FQDN to retrieve its corresponding IP address. The application server can provide the access credentials to authenticate. If authentication fails, then the GUI can prompt the user accordingly.

At stage 412, the application server can import the new host's image from the new host. For example, the new host can create an image file and send the file to the application server. Alternatively, stage 412 can occur after stage 420. For example, because an image file can be large and require significant bandwidth to import, the application server can first request only information about the new host's image, such as the OS version, executables, application data files, installed drivers, and so on. At stage 414, the application server can send the image information to the GUI. The GUI can present the image information to the user and require the user to confirm the new host before importing the image file.

The application server can check the security certificate of the new host before allowing the user to create a server cluster based on the new host's image. For example, if the new host is not known to the application server, the application server can request the new host's SSL, TLS, or other certificate. If the application server is unable to verify the certificate, then the GUI can notify the user and prompt the user to proceed if the user trust's the certificate or to cancel the process.

At stage 416, the GUI can display modification options for the image. For example, the GUI can allow the user to modify the image before the server cluster is created. As some examples, the user can add or remove drivers, executables, and so on. The modification options can be displayed in response to the user selecting a selection mechanism in the GUI. When the user selects to modify the image, the GUI can display a window with a list of modifications that can be made. For example, the GUI can display a list of components of the image that can be added, removed, or modified. The GUI can also include a feature that allows the user to add new components to the image, such as new drivers, executables, and applications. For example, the application server can have a library of applications that can be added to an image. These applications, and any other components that can be readily added, can be displayed in the GUI for the user choose. The GUI can also allow a user to upload drivers to be used in addition to, or in lieu of, the drivers in the current image.

At stage 418, the GUI can receive modification input from the user. For example, the user can select components to add or remove, upload any data files, and select any applications or other options to add or remove. At stage 420, the GUI can send the modification input to the application server. For example, the GUI can create a data file, such as an HTML file or a JSON file, that includes the modifications. The GUI can send the file to the application server, such as with an HTTP or API call.

At stage 422, the application server can create the server cluster. For example, the application server can create a cluster of VMs based on the imported image. The VMs can be installed on host devices in a location designated by the user, such as a specified data center. The application server can add and remove components from the selected image according to the modifications made by the user.

FIG. 5 is a flowchart of an example method for adding hosts to a server cluster managed with a single image. At stage 510, a GUI can present options for adding hosts to an existing server cluster that is managed by a single image. For example, the GUI can include an option for adding hosts to a server cluster. The option can require that the user identify the host. For example, the user can select the host using any available mechanism, such as selecting from a list or tree, or providing the host's IP address or FQDN.

The GUI can present multiple options for adding hosts to the identified server cluster. One option can allow the user to add hosts without importing an image. This would cause the application server to create new hosts using the image that the hosts currently in the cluster are already running. Another option can allow the application server to automatically determine the best image to use. For example, the application server can determine what image version the hosts are currently running and then determine where an updated version of the image is available. The application server can check the image versions of other clusters or known existing hosts running the same or similar images. If a higher-versioned image is available from one another existing hosts, then the application server can retrieve its image file and add hosts to the cluster using that image file. The application server can also update the hosts in the server cluster with the update image file so that all hosts are up-to-date and running the same image.

Another option can allow the user to choose a host to import an image from. at stage 520, the user can select this option. In response, the application server can retrieve a list of existing hosts in the system that are available for host seeding. The list of existing hosts can be retained at the application server or, alternatively, in a separate storage device like a database. Image availability can depend on a variety of factors. For example, users can be assigned policies that determine which hosts they can import an image from. Also, admins can designate whether a host's image can be used for host seeding.

At stage 530, the GUI can present a list of existing hosts from which an image can be imported. For example, the GUI can display a list of the existing hosts and information about the host's image. The image information can include the host's name, IP address, hypervisor version, and model, as some examples. The image information can also indicate a cluster that the host belongs to. The GUI can include a filtering tool that allows the user to locate the desired existing host more quickly. For example, the filtering tool can include a text field that actively filters the results based on user input. As an example, the user can input the IP address of the desired existing host. As the user inputs the IP address, the GUI can filter out hosts whose IP address does not match.

At stage 540, the GUI can receive a selection of one of the existing hosts. For example, the user can select a host from the list of existing hosts described above. Before creating a server cluster based on the selected host's image, the GUI can allow the user to customize the image. For example, when the user selects a host, the GUI can make an API call to a retrieve the image information for the selected host. The image information can include information like the image's ID, OS version, executables, application data files, installed drivers, and so on. The GUI can then allow the user to customize certain aspects of the image, such as by adding or removing drivers or other components.

At stage 550, the application server can import an image from the selected host. For example, the application server can instruct the selected host to create an image file and send it to the application server. In one example, the GUI can allow the user to import an image from a new host. For example, the user can provide an IP address or FQDN and access credentials for a new host, and the application server can import an image file from the new host.

At stage 560, the application server can add hosts to the cluster using the imported image. For example, the application server can create a cluster of VMs based on the selected host's image. The VMs can be installed on host devices in a location designated by the user, such as a specified data center. In one example, the GUI can allow the user to modify the image before the hosts are added to the cluster. The application server can add and remove components from the selected image according to the modifications made by the user. The GUI can allow the user to add the selected existing host to the server cluster in certain circumstances. For example, if the existing host is a standalone host (i.e., not part of a server cluster), then the GUI can present an option, such as a toggle button, that the user can select to add the existing host to the new server cluster. The application server can also update the image on hosts already in the cluster based. For example, the application server can update all the hosts in the cluster with the updated version of the image or with a new image selected by the user. This can allow all the hosts in the cluster to be managed by the same image.

A user can use this feature to update images in a server cluster without adding any additional hosts. For example, a newer version of an image used in a server cluster, or an image selected by the user, can be applied to hosts in the cluster. The GUI can allow the user to choose the number of hosts to add to the cluster with zero being an option. By selecting not to add any additional hosts, the application server can update the hosts in the cluster with the updated or selected image.

FIG. 6 is a sequence diagram of an example method for adding hosts to a server cluster managed with a single image. At stage 602, the GUI can display options for adding hosts to a server cluster. For example, a user can select an option in the GUI for adding hosts to a server cluster. In response, the GUI can display a window where the user can identify the server cluster for adding the new hosts to. After identifying the server cluster, the GUI can display options for how to add the new hosts to the server cluster. For example, one option can allow the user to add hosts without importing an image, which can cause application server to create new hosts using the image currently running on hosts in the cluster. Another option can allow the application server to automatically determine the best image to use. For example, the application server can identify the version of the image running on the hosts in the cluster and check for any updated versions. If, for example, a higher-versioned image is available from one an existing host in the same system, then the application server can retrieve its image file and add hosts to the cluster using that image file. The application server can also update the current hosts with the new image.

Another option can allow the user to choose an image to import, which the user can select at stage 604. In response, the GUI can notify the application server at stage 606. Then, at stage 608, the application server can identify existing hosts available for host seeding. The list of existing hosts can be retained at the application server or, alternatively, in a separate storage device like a database. Image availability can depend on a variety of factors. For example, users can be assigned policies that determine which hosts they can import an image from. Also, admins can designate whether a host's image can be used for host seeding.

At stage 610, the application server can send data about the available existing hosts to the GUI. The image information can include the host's name, IP address, hypervisor version, and model, as some examples. The image information can also indicate a cluster that the host belongs to. At stage 612, the GUI can display a list of hosts with available images and their corresponding image information.

At stage 614, the user can select an existing host. In one example, upon receiving a selection, the GUI can display additional information about the corresponding image. In one example, the application server can make an API call to the corresponding host to retrieve the additional image information. The image information can include information like the image's ID, OS version, executables, application data files, installed drivers, and so on. The GUI can also display information about the image currently running on the cluster so that the user can compare.

At stage 616, the GUI can display modification options for the selected host image. For example, the GUI can allow the user to modify the image before the server cluster is created. As some examples, the user can add or remove drivers, executables, and so on. In one example, the GUI can display components present in the existing image that are not preloaded in the new image being imported. The GUI can also allow the user to add all such components, or to individually select components, from the existing image to add to the new image. This can help the user more easily update a cluster to a new image while ensuring that the updated image is not missing any needed components.

At stage 618, the user can select modifications for the image. At stage 620, the GUI can send the image's ID and modifications to the application server. For example, the GUI can create a data file, such as an HTML, file or a JSON file, that includes the modifications. The GUI can send the file to the application server, such as with an HTTP or API call.

At stage 622, the application server can import the image from the selected host. For example, the application server can send instructions to the existing host to create an image file and send it to the application server. Upon receiving the image file, at stage 624, the application server can add the hosts to the server cluster using the imported image. If indicated by the user, the application server can also update the hosts already in the cluster with the new image. The GUI can allow the user to select how many hosts to add to the cluster, including zero. By not adding additional hosts the user can select an image for updating the hosts in the cluster.

FIGS. 7A, 7B, 7C, 7D, 7E, and 7F are illustrations of an example GUI 700 for creating a server cluster using an existing image. The GUI 700 includes tabs that correspond to pages that the user can encounter when creating a server cluster. A basics tab 702 corresponds to a basics page 708 where the user can provide basic information about the server cluster. For example, the user can input a cluster name 710 for the server cluster and designate a location 712 where the server cluster will be hosted. Other settings that the user can configure in the GUI 700 are the Distributed Resource Scheduler (“DRS”) toggle 714, High Availability (“HA”) toggle 716, and virtual storage area network (“vSAN”) toggle 718. Enabling the toggles 714, 716, and 718 can enable the corresponding feature on the cluster when the cluster is created. A DRS can refer to a workload management tool that segregates computing needs into different physical servers to balance resource capacity. An HA (meaning “high availability”) can refer to a feature that restarts a VM on another physical server when the physical server currently hosting the VM fails. vSAN can refer to a storage virtualization feature that provides cloud-based storage.

The GUI 700 can include a hosting option 720 that allows the user to designate that the hosts in the cluster be managed with a single image. The hosting option 720 can be a toggle mechanism, such as a toggle button or check box. Enabling the hosting option 720 can cause the GUI 700 to display options for managing the cluster with a single image. For example, a first option 722 creates the server cluster using a new image, a second option 724 allows the user to import an image from an existing host, and a third option 726 allows the user to import an image from a new host.

After selecting a method of cluster management, the GUI 700 can proceed to various image pages, depending on which option the user selects. If the user selects the first option 722, then the GUI 700 can display the new image window 728 illustrated in FIG. 7B. The new image window 728 allows the user to select an image from the image drop-down menu 730. The images available in the drop-down menu 730 can be based on predetermined based versions of images or hypervisors. The new image window 728 can also have an option to select a vendor addon 732, which can be an addon specific to a vendor.

If the user selects the second option 724 of FIG. 7A for importing an image from an existing host, then the GUI 700 can display the existing host page 734 illustrated in FIG. 7C. The existing host page 734 can include a window 736 that displays a list of existing hosts 738 that the user can choose from. The existing hosts 738 can be known hosts that are available for host seeding. Selecting an existing host 738 can cause the GUI 700 to display image information 740 about the selected existing host's image. For example, as shown in the existing host page 734, the user has selected the existing host 738 with the IP address “20.40.128.235.” In response, the application server that hosts the GUI 700 can make an API call to the corresponding host to retrieve additional information about its image, which is displayed in the image information 740.

If the user selects the third option 726 of FIG. 7A for importing an image from a new host, then the GUI 700 can display the new host page 742 illustrated in FIG. 7D. In the new host page 742, the user can provide the address 744 of the new host, which as shown in the new host page 742 can be an IP address or FQDN. The user can also provide access credentials in the form of a username 746 and password 748. When the user clicks the find host button 749, the application server can contact the new host using the address 744 and authenticate with the username 746 and password 748.

Moving to FIG. 7E, if authentication is successful, then the application server can cause the GUI 700 to display a new host details page 750 that includes information about the new host. For example, the new host window 752 displays the IP address of the new host and the image information window 754 displays information about the new host's image. The new host details page 750 also include an option 756 for moving the new host to the new cluster when the cluster is created.

FIG. 7F illustrates an example review page 758 of the GUI 700. The review page 758 can display details of the server cluster so that the user can review them before the server cluster is created. For example, the review page 758 can display the cluster's name, location, settings, where the image was imported from, and information about the image. If the user is satisfied, the user can select the finish button 760. In response, the application server can create the new server cluster based on the selected image.

FIGS. 8A and 8B are illustrations of an example GUI 800 for applying an image from an existing host to a server cluster. FIG. 8A displays an example import page 804, which is designated by the import image tab 802. The import page 804 can be displayed after the user has selected a server cluster to apply the image to. As shown in FIG. 8A, the user has selected an option 808 for selecting a host to import an image from. The existing hosts 812 available for host seeding are shown in the existing host list 810. This gives the user the option to select an image of an existing host 812 and applying that image to an existing server cluster or to add new hosts to a cluster with the selected image. For example, as shown in FIG. 8A, the user has selected the existing host 812 with the IP address “20.40.128.236.” In response to that selection, the application server can make an API call to the corresponding host to retrieve new image information 814, which is information about the image on the selected existing host 812. The GUI 800 can also display existing image information 816, which is information about the image currently installed on the hosts in the server cluster.

FIG. 8B illustrates an example review page 820 of the GUI 800, which is indicated by the ready to complete tab 822. The review page 820 can display details of the server cluster so that the user can review them before the image is applied to the server cluster. For example, the review page 820 can display hosts that will be moved to the cluster, information about the image being applied to the cluster, and other settings and information about the image. If the user is satisfied, the user can select the finish button 824. In response, the application server can apply the image to the hosts in the server cluster. This can include, for example, adding new hosts using the selected image, updating the existing hosts in the cluster with the selected image, and adding selected hosts already running the image to the server cluster.

FIG. 9 is an illustration of an example system for applying an existing server image to a cluster. One or more application servers 920 can host an application 912 for managing server clusters. The application 912 can include a GUI 914, which can be a front-end interface of the application 912 that a user can interact with for managing server clusters. The application server 920 can be one or more servers or a group of servers, including multiple servers implemented virtually across multiple computing platforms. For example, the application 912 can be hosted by a web server, and a user can access the application 912 through a web browser. Alternatively, the application 912, the GUI 914, or other components of the application 912 may be installed directly on a user device 910. The user device 910 can be one or more processor-based devices, such as a personal computer, tablet, or cell phone. The application 912 can communicate with the application server 920 using any kind of Internet protocol, such as HTTP and API calls. Actions described herein as being performed by the GUI 914 can be performed by the corresponding application 912 or application backend 922 rather than the GUI 914 itself.

The application server 920 can be a physical hardware server or can virtually run as one or more servers running on one or more physical hardware devices. The application server 920 can access information for applying images from one or more databases 930. For example, the database 930 can store hypervisors 932 that the application server 920 can use to create server clusters composed of VMs. The database 930 can also retain a list of existing hosts 934. Existing host 934 can refer to a known host in a system that is available for host seeding. If a user selects an existing host 934 in the GUI 914, then the application server can make an API call to the selected host to retrieve information about the host's image to present to the user. If the user chooses to create a new cluster using the selected host's image, or to apply the host's image to an existing server cluster, then the application server can contact the existing host 934 to retrieve an image file.

If a user chooses to apply an image from a new host 940, then the GUI 914 can prompt the user for access credentials. The application server 920 can contact the new host 940, such as with an HTTP call using an IP address provided by the user, to authenticate with the server, retrieve its security certificate, and retrieve information about its image 942. If the user confirms the image 942 of the new host 940, then the application server 920 can retrieve an image file of the image 942 from the new host 940 and apply the image 942 accordingly.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for applying an image to a server cluster, comprising:
presenting, in a graphical user interface (“GUI”), a plurality of options for creating the server cluster based on a single image, the plurality of options including importing an image from an existing host and importing an image from a new host, an existing host being a host known to be available for host seeding and a new host being a host not known to be available for host seeding; and
in an instance where a selection is received for importing an image from an existing host, creating the server cluster by performing stages comprising:
presenting, in the GUI, at least one existing host that can be applied to the server cluster;
receiving a selection of one of the at least one existing hosts; and
applying a first image to servers in the server cluster, the first image being an image of the selected existing host.

2. The method of claim 1, wherein, in an instance where a selection is received for importing an image from a new host, creating the server cluster comprises:
presenting, in the GUI, a prompt for providing an address and access credentials for the new host;
receiving the address and access credentials for the new host;
authenticating with the new host using the access credentials;
importing a second image from the new host, the second image being an image of the new host; and
applying the second image to servers in the server cluster.

3. The method of claim 2, wherein the GUI includes an option for modifying the image being applied to the server cluster by adding or removing components of the image.

4. The method of claim 2, wherein the GUI includes an option that, when selected, causes the new host to become available as an existing host when creating future server clusters.

5. The method of claim 1, wherein the GUI includes an option that, when selected, causes the selected existing host to be added to the server cluster.

6. The method of claim 1, wherein applying the first image to servers in the server cluster includes creating at least one virtual machine using the first image.

7. The method of claim 1, wherein the GUI includes an option for creating a new image to apply to the server cluster based on a stored hypervisor.

8. A non-transitory, computer-readable medium containing instructions that, when executed by a hardware-based processor, causes the processor to perform stages for applying an existing image to a server cluster, the stages comprising:
presenting, in a graphical user interface (“GUI”), a plurality of options for creating the server cluster based on a single image, the plurality of options including importing an image from an existing host and importing an image from a new host, an existing host being a host known to be available for host seeding and a new host being a host not known to be available for host seeding; and
in an instance where a selection is received for importing an image from an existing host, creating the server cluster by performing stages comprising:
presenting, in the GUI, at least one existing host that can be applied to the server cluster;
receiving a selection of one of the at least one existing hosts; and
applying a first image to servers in the server cluster, the first image being an image of the selected existing host.

9. The non-transitory, computer-readable medium of claim 8, wherein, in an instance where a selection is received for importing an image from a new host, creating the server cluster comprises:
presenting, in the GUI, a prompt for providing an address and access credentials for the new host;
receiving the address and access credentials for the new host;
authenticating with the new host using the access credentials;
importing a second image from the new host, the second image being an image of the new host; and
applying the second image to servers in the server cluster.

10. The non-transitory, computer-readable medium of claim 9, wherein the GUI includes an option for modifying the image being applied to the server cluster by adding or removing components of the image.

11. The non-transitory, computer-readable medium of claim 9, wherein the GUI includes an option that, when selected, causes the new host to become available as an existing host when creating future server clusters.

12. The non-transitory, computer-readable medium of claim 8, wherein the GUI includes an option that, when selected, causes the selected existing host to be added to the server cluster.

13. The non-transitory, computer-readable medium of claim 8, wherein applying the first image to servers in the server cluster includes creating at least one virtual machine using the first image.

14. The non-transitory, computer-readable medium of claim 8, wherein the GUI includes an option for creating a new image to apply to the server cluster based on a stored hypervisor.

15. A system for applying an existing image to a server cluster, comprising:
a memory storage including a non-transitory, computer-readable medium comprising instructions; and
a hardware-based processor that executes the instructions to carry out stages comprising:
presenting, in a graphical user interface (“GUI”), a plurality of options for creating the server cluster based on a single image, the plurality of options including importing an image from an existing host and importing an image from a new host, an existing host being a host known to be available for host seeding and a new host being a host not known to be available for host seeding; and
in an instance where a selection is received for importing an image from an existing host, creating the server cluster by performing stages comprising:
presenting, in the GUI, at least one existing host that can be applied to the server cluster;
receiving a selection of one of the at least one existing hosts; and
applying a first image to servers in the server cluster, the first image being an image of the selected existing host.

16. The system of claim 15, wherein, in an instance where a selection is received for importing an image from a new host, creating the server cluster comprises:
presenting, in the GUI, a prompt for providing an address and access credentials for the new host;
receiving the address and access credentials for the new host;
authenticating with the new host using the access credentials;
importing a second image from the new host, the second image being an image of the new host; and
applying the second image to servers in the server cluster.

17. The system of claim 16, wherein the GUI includes an option for modifying the image being applied to the server cluster by adding or removing components of the image.

18. The system of claim 17, wherein the GUI includes an option that, when selected, causes the new host to become available as an existing host when creating future server clusters.

19. The system of claim 15, wherein the GUI includes an option that, when selected, causes the selected existing host to be added to the server cluster.

20. The system of claim 15, wherein applying the first image to servers in the server cluster includes creating at least one virtual machine using the first image.
